(19) United States
(12) Patent Application Publication
(10) Pub. No.: US 2020/0136425 A1
(43) Pub. Date: Apr. 30, 2020

(54) WIRELESS COMMUNICATION SYSTEM AND METHOD POWERED BY AN ENERGY HARVESTER

(71) Applicant: SEMICONDUCTOR COMPONENTS INDUSTRIES, LLC, Phoenix, AZ (US)

(72) Inventor: Bruno DAMIEN, Voisins le Bretonneux (FR)

(73) Assignee: SEMICONDUCTOR COMPONENTS INDUSTRIES, LLC, Phoenix, AZ (US)

(21) Appl. No.: 16/169,029

(22) Filed: Oct. 24, 2018

(51) Int. Cl. H02J 7/34; G05F 3/18; H02M 7/06; H02N 2/18

(52) U.S. Cl. CPC H02J 7/345; H02N 2/181; H02M 7/066; G05F 3/18

(57) ABSTRACT

Wireless communication system and method powered by an energy harvester. At least some of the example embodiments are methods including: receiving a burst of electrical energy from an energy harvester that produces the burst of electrical energy from mechanical energy, the burst of electrical energy the result of a single actuation of the energy harvester; rectifying the burst of electrical energy to create rectified energy; applying the rectified energy to the transceiver without applying the rectified energy to a switching power converter; and transmitting an electromagnetic switch including a frame of multiple bytes, the transmitting using the rectified energy. Additional embodiments can include a transceiver system including an energy harvester, a rectifier, a capacitor, and a transceiver, where the transceiver is configured to transmit an electromagnetic signal including a frame of a plurality of bytes during each burst of electrical energy.

### CROSS-REFERENCE TO RELATED APPLICATIONS

Not Applicable.

### BACKGROUND

In order to reduce cost, to reduce consumption of resources, and to reduce waste, many devices and systems that have traditionally been wired systems are moving to wireless communications. As an example, in home and building automation, rather than string copper cables between devices, the devices may communicate wirelessly. As a more specific example, wall switches have traditionally been wired into the 120 Volt alternating current (AC) signal to control other devices, such as lighting fixtures. The wall switches may be replaced with switches that appear to the outside observer as a standard wall switch, but which may communicate on and off commands to the lighting fixture wirelessly, which reduces the need to string conductors between the devices (e.g., between the wall switch the lighting fixture).

### BRIEF DESCRIPTION OF THE DRAWINGS

For a detailed description of example embodiments, reference will now be made to the accompanying drawings in which:

FIG. 1 shows, in block diagram form, a transceiver system;

FIG. 2 shows, in block diagram form, a transceiver system in accordance with at least some embodiments;

FIG. 3 shows a circuit diagram of a transceiver system in accordance with at least some embodiments;

FIG. 4 shows a circuit diagram of a transceiver system in accordance with at least some embodiments; and

FIG. 5 shows a method in accordance with at least some embodiments.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

“Energy harvester” shall mean a device that creates electrical energy from mechanical energy in the form of actuation of the device. For example, changing switch positions of the device, or compressing the device, produces mechanical energy (movement) that is converted to electrical energy. “Energy harvester” shall not include: electrical generators, such as gas turbines, steam-driven turbines coupled to electrical generators, or electrical generators turned by internal combustion engines; wind turbines of any size; batteries; or regenerative braking systems.

“Transmit” or “transmitting” an “electromagnetic signal” shall mean sending an electromagnetic wave through a non-conductive medium, such as atmospheric air or other gaseous medium. Electrical current moving along and/or through a conductor shall not be considered an electromagnetic signal.

In relation to electrical devices, the terms “input” and “output” refer to electrical connections to the electrical devices, and shall not be read as verbs requiring action. For example, a controller may have a gate output and one or more sense inputs.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various embodiments are directed to a wireless communication system and method powered by an energy harvester. More particularly, example embodiments are directed to a cost effective battery-less wireless communication system powered with damped oscillator energy provided from an energy harvester. Example energy harvesters may include a mechanical switch configured to generate a burst of electrical energy with each actuation, or a piezoelectric device configured to generate a burst of electrical energy with each compression. More particularly still, example embodiments are directed to transceiver systems that apply a burst of electrical energy from an energy harvester to a rectifier, and the rectified energy is applied directly to a transceiver without applying the rectified energy to a switching power supply. The specification first turns to a related art system to highlight differences between related art systems and the various embodiments.

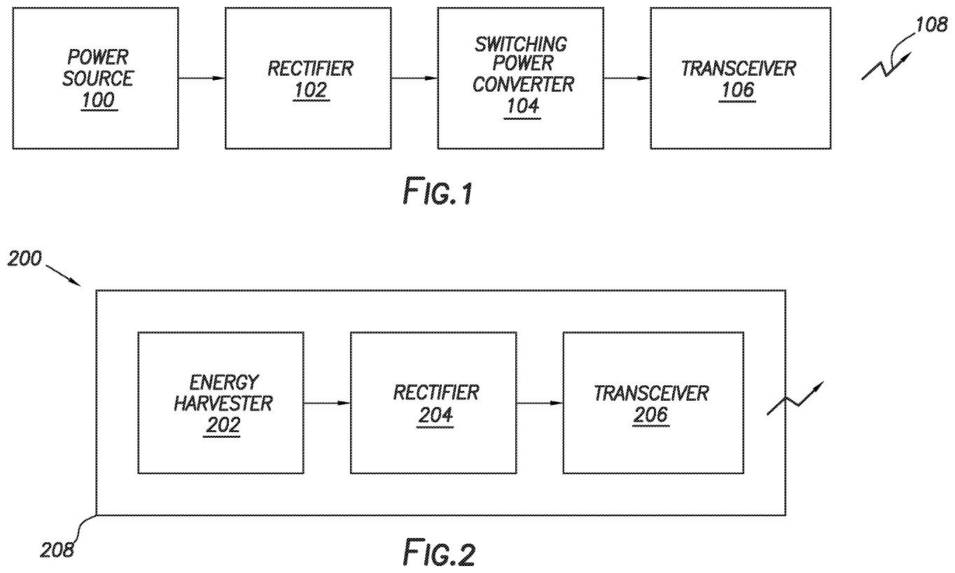

FIG. 1 shows, in block diagram form, a transceiver system. In particular, FIG. 1 shows a transceiver system comprising a power source 100, a rectifier 102, a switching power converter 104, and a transceiver 106. The power source 100 creates a small amount of electrical power, usually in the micro-Joule range, with peak voltages that may be as high as 100 Volts. The electrical power created by the power source 100 may be an alternating current (AC), and thus is applied to a rectifier 102. The rectifier 102, as the name implies, rectifies the electrical power. The electrical power is then applied to a switching power converter 104, such as a buck-boost converter. A buck-boost converter may, during periods of time when the voltage from the rectifier 102 is high, lower the voltage (buck operation). The buck-boost converter may also, during periods of time when the voltage from the rectifier 102 is low, increase the voltage (boost operation). The switching power converter 104 thus ensures that the voltage of the electrical power provided to the transceiver 106 is within the transceiver's operating range for the period of time used by the transceiver to send signals electromagnetically to other devices (the electromagnetic signals shown by arrow 108).

In the related art, an amount of time in which the transceiver 108 is active to send messages is longer than the period of time that the voltage of the electrical power produced by the power source 100 is above the lower limit of the operating voltage of the transceiver 106. Thus, related art devices use the switching power converter 104 not only to lower peak voltages of the electrical power provided to the transceiver 106, but also increase the voltage of the electrical power provided to the transceiver 106. In short, related art devices would not be operational but-for the switching power converter 104. Thus, one of ordinary skill in the art includes, as a matter of course, a switching power converter 104 in transceiver systems to ensure the voltage of the electrical power supplied to the transceiver 106 is within the operating range.

The inventor of the present specification has found that transceiver systems using transceivers with relatively low supply voltage requirements may omit the switching power converter 104, and yet still be operational. The inventor of the present specification has found that transceivers transmitting relatively short time span electromagnetic signals may omit the switching power converter 104. The inventor of the present specification has found that by reducing power loss in the rectifier, such as by using Schottky diodes in the rectifier, transceiver systems may omit the switching power converter 104. Each of these discoveries may be used alone or in combination. The specification thus turns to the example embodiments.

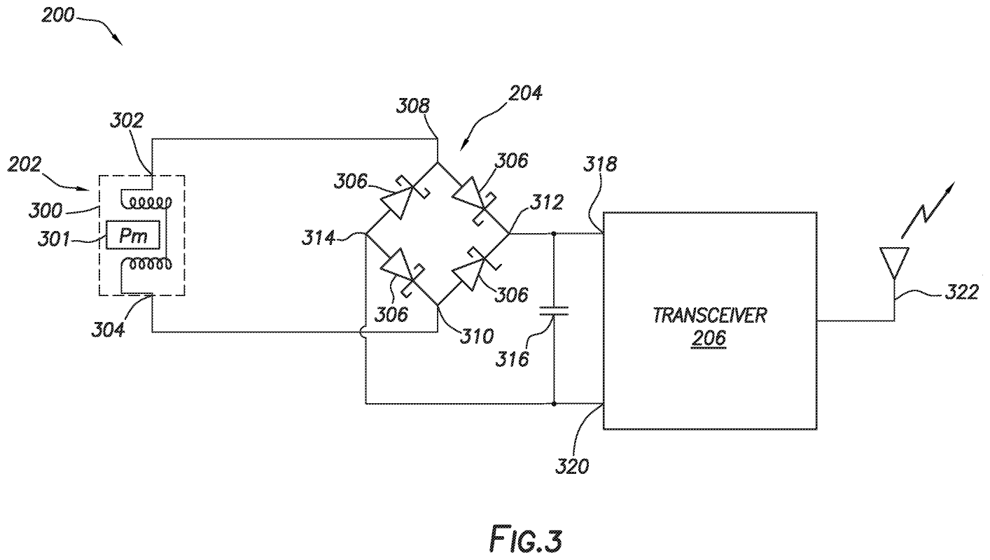

FIG. 2 shows, in block diagram form, a transceiver system in accordance with at least some embodiments. In particular, FIG. 2 shows a transceiver system 200 comprising an energy harvester 202, a rectifier 204, and a transceiver 206. In some example systems, the various components are both mechanically and electrically coupled to a printed circuit board (PCB) 208, and thus may be sold or used as an integrated product.

The energy harvester 202 is configured to produce a burst of electrical energy upon each actuation of the energy harvester. Each burst of electrical energy may have duration of 10 milliseconds or less. In some example systems, the burst of electrical energy created by the energy harvester 202 may be no more than 500 micro-Joules, and in a particular case between and including 300 micro-Joules and 500 micro-Joules. In some cases the peak voltage associated with the burst of electrical energy is 100 Volts or less, in some cases 7 Volts or less, and in yet still other cases between 3 and 7 Volts inclusive. In most cases the burst of electrical energy is the result of the single actuation of the energy harvester. After the burst of electrical energy has dissipated, the voltage and current produced by the energy harvester 202 ceases (e.g., go to zero) until the next actuation.

Thus, the energy harvester 202 is a non-continuous power supply (e.g., is not a battery or a solar cell). The burst of energy created by the energy harvester may be a highly damped AC waveform (that is, having a high damping factor). In example systems, the energy harvester 202 may be a mechanical switch configured to produce the burst of electrical energy upon actuation. That is, the mechanical switch, when actuated, moves a permanent magnet associated with the coil of wire to produce the burst of electrical energy. Mechanical switches that generate bursts of electrical energy may be purchased from any suitable source, such as the model AFIM or AGIM series available from ZF Electronic Systems Pleasant Prairie, LLC, of Pleasant Prairie, Wis. In yet still other cases, the energy harvester 202 may be a piezoelectric device configured to produce the burst of electrical energy upon being compressed, such as: part number KEH-007 from Piezo Systems of Woborn, Massachusets, USA; or a P-876 DuraAct Patch Transducer from PI Ceramic GmbH of Lederhose, Thuringia, Germany.

Still referring to FIG. 2, the example transceiver system 200 further comprises a rectifier 204 electrically coupled to the energy harvester 202. The rectifier 204 receives the burst of electrical energy, rectifies the burst of electrical energy, and thereby creates rectified energy. In some example cases, the rectifier 204 is a single diode arranged for half-wave rectification. In other cases, the rectifier 204 is a full-wave bridge arranged for full-wave rectification. In example embodiments, the rectifier comprises a full-wave bridge constructed of Schottky diodes. Schottky diodes are used to reduce the forward voltage drop across each diode and thus preserve more electrical energy to provide to the transceiver 206. As will be discussed more below, the rectifier 204 may be used in conjunction with a capacitor (not shown in FIG. 2) to filter the rectified energy supplied to the transceiver 206. And as shown, the rectified energy is applied to the transceiver 206 without applying the rectified energy to a switching power converter.

The transceiver 206 is coupled to the rectifier 204 and receives the rectified energy. The transceiver 206, when powered by the rectified energy, is configured to transmit an electromagnetic signal using the rectified energy, the electromagnetic signal comprising a frame of multiple bytes. In example embodiments, the transceiver 206 is designed and constructed to operate when the voltage supplied to the transceiver 206 is 3.3 Volts and below, and in a particular case between 1.0 and 1.6 Volts inclusive. Other voltages ranges are contemplated, including lower voltage ranges if such transceivers become available. In example cases, the transceiver 206 may be any after-developed or currently available transceiver, such as any of the following low power systems-on-chip available from ON Semiconductor of Phoenix, Ariz.: NCS36510 (2.4 GHz IEEE 802.15.4 Applications); RSL10 (2.4 GHz BLUETOOTH® 5 Applications); AX-SFEU (SIGFOX® Compliant); or AXM0F243 (27-1050 MHz).

In the example embodiments the transceiver 206 operates under a transmission protocol that reduces power used to transmit electromagnetic signals comprising a frame of more bytes. The transceiver 206 may be specifically designed and constructed to operate under a particular protocol (e.g., the NCS36510 noted above), or the transceiver 206 may be programmed to operate under an appropriate protocol. The example transceiver 206 may operate under suitable low power protocol, such as: the ZIGBEE GREEN POWER (GP) protocol promulgated by the Zigbee Alliance; the Institute of Electrical and Electronics Engineers (IEEE) 802.15.4 technical standard; BLUETOOTH® 5 (BLES) as promulgated by the Bluetooth Special Interest Group; and any number of proprietary protocols.

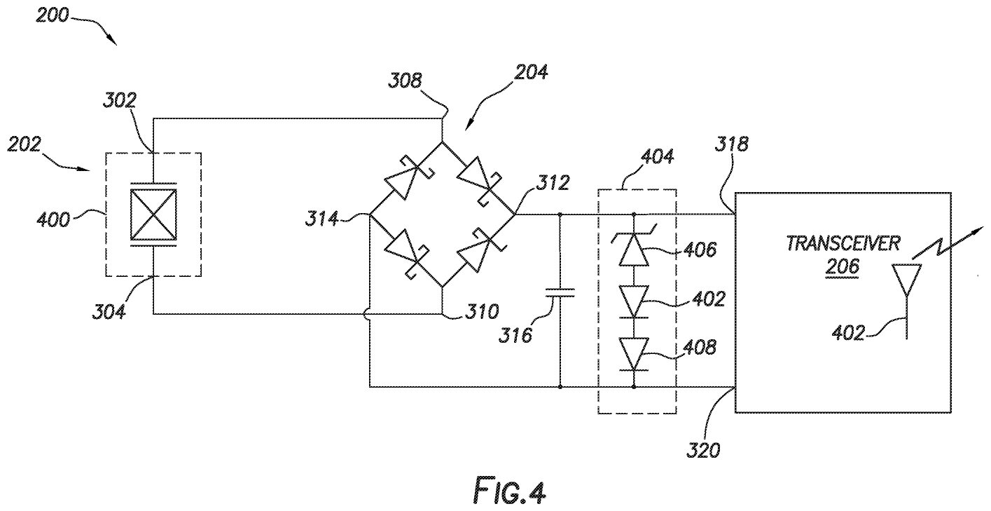

FIG. 3 shows a circuit diagram of a transceiver system 200 in accordance with at least some embodiments. In particular, FIG. 3 shows the energy harvester 202 in the form of a mechanical switch 300 that moves a permanent magnet (PM) 301 with each actuation, and with each actuation creates a burst of electrical energy. The mechanical switch 300 defines a burst output 302 and a return 304.

FIG. 3 further shows rectifier 204 in the example form of a full-wave bridge comprising four Schottky diodes 306. The rectifier 204 defines AC inputs 308 and 310 coupled to the burst output 302 and return 304, respectively. The example rectifier 204 further defines a DC output 312 and a return 314. Again, the rectifier 204 is designed and constructed to receive a burst of electrical energy from the energy harvester 202 in the form of a highly damped AC signal, and rectify the AC signal to create rectified energy.

The example transceiver system 200 further comprises a capacitor 316 coupled across the DC output 312 and return 314. The capacitor 316 is used to smooth the voltage of the rectified energy such that, at its peak, the voltage is no higher than the acceptable input voltage applied to the transceiver 206.

Still referring to FIG. 3, the transceiver 206 is shown in block diagram form, but again may be any after developed, or currently available, transceiver discussed above. The transceiver 206 defines a power input 318 coupled directly to the DC output 312 of the rectifier 204. The transceiver 206 also defines a common or return 320 coupled directly to the return 314 of the rectifier 204. As previously mentioned, the transceiver 206 is configured to transmit an electromagnetic signal comprising a frame of a plurality of bytes during each burst of electrical energy. In some cases, and as shown, the transceiver 206 may be coupled to an external antenna 322, but in other cases (e.g., the NCS36510), the antenna may be integral with the transceiver 206.

The example transceiver system 200 of the FIG. 3 may be used in a wide variety of circumstances. For example, the transceiver system 200 may be used as a wall switch to control an electrical device, such as a lighting system or a ceiling fan. That is, when the energy harvester 202 is actuated, the transceiver 206 may transmit an electromagnetic signal comprising a frame of multiple bytes to a base unit, with the electromagnetic signal directing a change of state of the controlled device. The example transceiver system 200 may be used as an intrusion detection system, detecting the opening of windows or doors, and transmitting the electromagnetic signal to a monitoring unit. When the energy harvester 202 is an example piezoelectric device, the transceiver system 200 may be used as a step counter (e.g., the piezoelectric device embedded in a user's shoe) to log exercise. As another example of the energy harvester 202 being a piezoelectric device, the transceiver system 200 may be used as patient monitor (e.g., the piezoelectric device embedded in the bed or frame to detect movement of the patient). Other example transceiver systems may be used as push button devices (e.g., emergency shutdown, or emergency break), collision detection circuits, and asset counting devices, just to name a few.

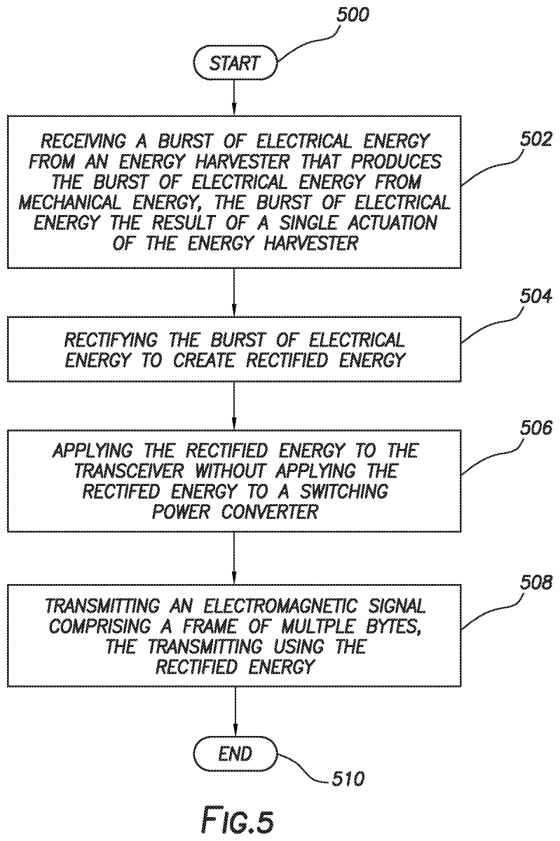

FIG. 4 shows a circuit diagram of a transceiver system in accordance with at least some embodiments. In particular, FIG. 4 shows the energy harvester 202 in the form of a piezoelectric element or device 400. Each time the piezoelectric device 400 is actuated by placing the piezoelectric device 400 in compression and/or tension, a burst of electrical energy is created. The piezoelectric device 400 defines a burst output 302 and a return 304.

FIG. 4 further shows rectifier 204 again in the example form of a full-wave bridge comprising four Schottky diodes. As before, the AC inputs 308 and 310 are coupled to the burst output 302 and return 304, respectively. Again as before, DC output 312 and return 314 are coupled directly to the transceiver 206. The example transceiver 206 of FIG. 4 includes an internal antenna 402, but otherwise operates as discussed above. The example transceiver system 200 of FIG. 4 again comprises a capacitor 316 coupled across the DC output 312 and return 314.

The example transceiver system 200 of FIG. 4 additionally includes an optional voltage clamp circuit 404. The voltage clamp circuit 404 couples across the capacitor 316, and as the name implies is configured to clamp or limit the voltage applied to the transceiver 206. The example voltage clamp circuit 404 comprises a Zener diode 406 in series with one or more further diodes 408. The breakdown voltage of the Zener diode 406 in combination with the number of further diodes 408 sets the clamp voltage for the voltage clamp circuit 404. In one example system, the clamp voltage for the voltage clamp circuit 404 is 1.6 Volts, being the upper supply limit voltage for the transceiver 206. The voltage clamp circuit 404 is shown in FIG. 4 with the piezoelectric device 400; however, a voltage clamp circuit 404 may be used with any energy harvester 202. And it follows that the voltage clamp circuit 404 need not be used just because the energy harvester is a piezoelectric device 400.

Situations in which the transceiver system 200, that does not include a switching power converter, may be used may be determined based on the following equation:

(V_{T}×I_{T})×T_{F}=Energy (1)

where V_{T} is the operating voltage of the transceiver, I_{T} is the average operating current of the transmitter during transmission of electromagnetic signals, T_{F} is the transmission time, and Energy is the energy budget to be available at the power input 318 of the transceiver. For example, a transceiver 206 when energized may: draw an initial inrush current; utilize a certain amount of power to perform wakeup functions; transmit an electromagnetic signal comprising a frame of multiple bytes; change channels and retransmit; and then utilize a certain amount of power to return to a coma state.

Consider a transceiver operating at 1.0 Volt. Further consider that the transceiver uses an average current of 3.4 milliamps during an activation having a duration of 10 milliseconds. Applying Equation (1) above, the energy budget is 34 micro-Joules. Thus, the combination of the energy harvester 202, the rectifier 204, and capacitor 316 are selected to ensure that at least 34 micro-Joules of power are available during the 10 millisecond activation time.

FIG. 5 shows a method in accordance with at least some embodiments. In particular, the method starts (block 500) and includes: receiving a burst of electrical energy from an energy harvester that produces the burst of electrical energy from mechanical energy, the burst of electrical energy the result of a single actuation of the energy harvester (block 502); rectifying the burst of electrical energy to create rectified energy (block 504); applying the rectified energy to the transceiver without applying the rectified energy to a switching power converter (block 506); and transmitting an electromagnetic signal comprising a frame of multiple bytes, the transmitting using the rectified energy (block 508). Thereafter the method ends (block 510).

Many of the electrical connections in the drawings are shown as direct couplings having no intervening devices, but not expressly stated as such in the description above. Nevertheless, this paragraph shall serve as antecedent basis in the claims for referencing any electrical connection as “directly coupled” for electrical connections shown in the drawing with no intervening device(s).

The above discussion is meant to be illustrative of the principles and various embodiments of the present invention. Numerous variations and modifications will become apparent to those skilled in the art once the above disclosure is fully appreciated. For example, combinations of energy harvesters may be used. As another example, non-Schottky diodes may be used in the rectifier if the energy harvester delivers sufficient energy. It is intended that the following claims be interpreted to embrace all such variations and modifications.

1. A method of operating a transceiver comprising:
receiving a burst of electrical energy from an energy harvester that produces the burst of electrical energy from mechanical energy, the burst of electrical energy the result of a single actuation of the energy harvester;
rectifying the burst of electrical energy to create rectified energy;
applying the rectified energy to the transceiver without applying the rectified energy to a switching power converter; and
transmitting an electromagnetic signal comprising a frame of multiple bytes, the transmitting using the rectified energy.

2. The method of claim 1 wherein receiving the burst of electrical energy further comprises receiving the burst of electrical energy from a mechanical switch configured to produce the burst of electrical energy upon actuation.

3. The method of claim 1 wherein receiving the burst of electrical energy further comprises receiving the burst of electrical energy from a piezoelectric device configured to produce the burst of electrical energy upon being compressed.

4. The method of claim 1 wherein receiving the burst of electrical energy further comprises receiving no more than 500 micro-Joules.

5. The method of claim 4 wherein receiving the burst of electrical energy further comprises receiving the burst of electrical energy within a time window of 10 milliseconds or less, and the burst of electrical energy ceasing thereafter.

6. The method of claim 1 wherein receiving the burst of electrical energy further comprises receiving the burst of electrical energy within a time window of 10 milliseconds or less, and the burst of electrical energy ceasing thereafter.

7. The method of claim 1 wherein rectifying the burst of electrical energy further comprises rectifying by way of a full-wave bridge of Schottky diodes having a capacitor coupled across direct current (DC) outputs of the full-wave bridge.

8. A transceiver system comprising:
an energy harvester configured to produce a burst of electrical energy upon each actuation of the energy harvester, each burst of electrical energy having a duration of 10 milliseconds or less;
a rectifier coupled to the energy harvester, the rectifier defining a direct current (DC) output and a return;
a capacitor coupled across the DC output and the return; and
a transceiver defining a power input coupled directly to the DC output of the rectifier;
the transceiver configured to transmit an electromagnetic signal comprising a frame of a plurality of bytes during each burst of electrical energy.

9. The transceiver system of claim 8 wherein the energy harvester is a mechanical switch that moves a permanent magnet with each actuation.

10. The transceiver system of claim 8 wherein the energy harvester is a piezoelectric device configured to produce the burst of electrical energy upon being compressed.

11. The transceiver system of claim 8 wherein the energy harvester is configured to produce 500 micro-Joules or less of energy with each actuation.

12. The transceiver system of claim 8 wherein the energy harvester is configured to produce a peak voltage of 3 Volts or greater during each actuation.

13. The transceiver system of claim 8 wherein the rectifier further comprises a full-wave rectifier comprising four Schotkky diodes.

14. The transceiver system of claim 8 wherein the transceiver is configured to operate during periods of time when a voltage on the power input is between and including 1.0 and 1.6 volts.

15. The transceiver system of claim 8 further comprising a printed circuit board, and wherein the energy harvester, the rectifier, the capacitor, and the transceiver are mechanically and electrically coupled to the printed circuit board.

16. A transceiver module comprising:
a printed circuit board;
a rectifier mechanically coupled to the printed circuit board, the rectifier defining alternating current (AC) inputs, a direct current (DC) output, and a return, the rectifier configured to receive at the AC inputs a burst of electrical energy having a duration of 10 milliseconds or less; and
a transceiver mechanically coupled to the printed circuit board, the transceiver defining a power input coupled directly to the DC output of the rectifier;
the transceiver configured to transmit an electromagnetic signal comprising a frame of a plurality of bytes during the burst of electrical energy.

17. The transceiver module of claim 16 further comprising a capacitor coupled across the DC output and the return.

18. The transceiver module of claim 16 wherein the rectifier is further configured to receive the burst of electrical energy of 500 micro-Joules or less.

19. The transceiver module of claim 16:
wherein the rectifier is configured to receive the burst of electrical energy of between and including 3 Volts and 7 Volts; and
wherein the transceiver is configured to operate during periods of time when a voltage on the power input is between and including 1.0 and 1.6 volts.

20. The transceiver system of claim 16 wherein the rectifier further comprises a full-wave rectifier comprising four Schotkky diodes.
